(19) United States
(12) Patent Application Publication
(10) Pub. No.: US 2015/0242078 A1
(43) Pub. Date: Aug. 27, 2015

(54) METHOD AND APPARATUS FOR CAPTURING, SHARING, AND REPLICATING USER ACTIVITY THROUGH AN APPLICATION WORKFLOW

(71) Applicant: ENDGAME SYSTEMS, INC., Atlanta, GA (US)

(72) Inventors: Earle W. Ady, San Francisco, CA (US); John Herren, Atlanta, GA (US); Philip Thrasher, Marietta, GA (US); Christopher T. Moultrie, Decatur, GA (US)

(73) Assignee: ENDGAME SYSTEMS, INC., Atlanta, GA (US)

(21) Appl. No.: 14/186,891

(22) Filed: Feb. 21, 2014

(51) Int. Cl. G06F 3/0484; G06F 17/30; G06F 17/24

(52) U.S. Cl. CPC G06F 3/0484; G06F 3/04842; G06F 17/241; G06F 17/30575; G06F 17/30392

(57) ABSTRACT

An improved method and apparatus for capturing, sharing, and replicating user activity through an application workflow is disclosed. The system enables a first user to share a history of an entire navigation sequence with a second user, and it enables the second user to replicate the entire navigation sequence.

An improved method and apparatus for capturing, sharing, and replicating user activity through an application workflow is disclosed.

### BACKGROUND OF THE INVENTION

Numerous systems exist that permit a user to navigate through possible nodes within an application workflow. Each node is associated with a data set. The node also can be associated with information regarding the history of how the data set was created (such as through the use of certain search criteria) or regarding the presentation of the data set. In some situations, a graphical representation can be generated for the node.

A typical prior art system is depicted in FIG. 1. Here, a user can navigate from screen 10 to screen 20 to screen 30. Screen 10 can be, for example, a home page for a web site or a starting page for a different type of data presentation system. Screen 20 is a screen that can be accessed from screen 10, such as by clicking a link, entering data, or making a selection on screen 10. Similarly, screen 30 is a screen that can be accessed from screen 20, such as by clicking a link, entering data, or making a selection on screen 20. Screen 10 is associated with data structure 11, screen 20 is associated with data structure 21, and screen 30 is associated with screen 31.

In the prior art system of FIG. 1, when a first user wishes to share information with a second user regarding screen 30, typically some portion of data structure 31 will be sent to the second user. Data structure 31 might include, for example, results from a search performed within a data set as shown on screen 30.

One limitation of the prior art system, however, is that it is not possible for the first user to share with the second user the history of how the first user arrived at screen 30. For example, data structure 31 would not include any information as to how the first user caused the traversal from screen 20 to screen 30 (selecting a link, entering data, etc.). Similarly, data structure 31 would not include any information as how the first user caused the traversal from screen 10 to screen 20, nor would data structure 21 include that information.

What is needed is a method and apparatus for capturing, sharing, and replicating the history of an entire navigation sequence.

### SUMMARY OF THE INVENTION

The aforementioned problems and needs are addressed by a system that captures the history of an entire navigation sequence. The system enables a first user to share a history of an entire navigation sequence with a second user, and it enables the second user to replicate the entire navigation sequence.

### BRIEF DESCRIPTION OF THE DRAWINGS

FIG. 1 is a depiction of a prior art system for traversing a series of screens within a data system.

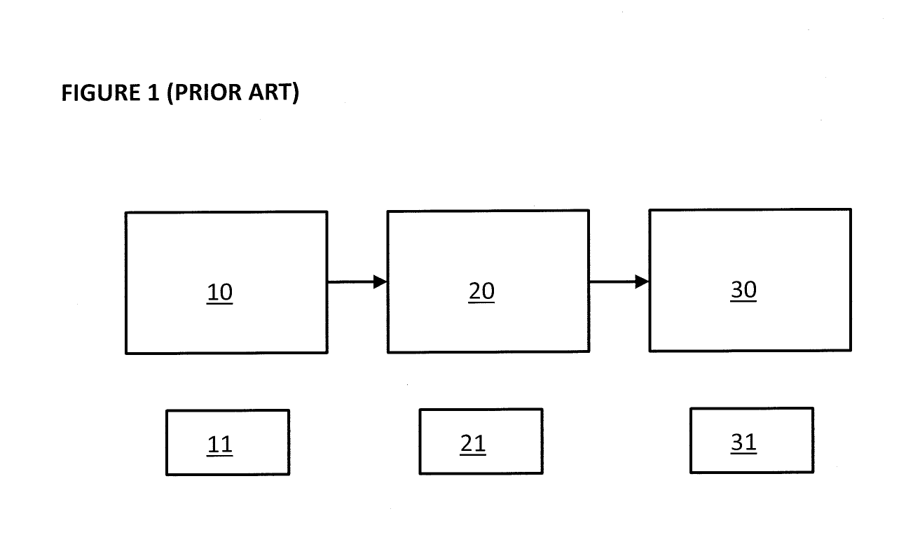

FIG. 2 is a depiction of an embodiment for traversing a series of screens within a data system and generating associated data structures.

FIG. 3 is a depiction of exemplary contents of one of the data structures depicted in FIG. 2.

FIG. 4 is a depiction of a permalink for accessing a previously generated screen and associated data structure

FIG. 5 is a depiction of an embodiment for traversing a series of screen within a data system and generating two sets of associated data structures.

FIG. 6 is a depiction of exemplary data structures associated with navigation through a series of screens generated by a data system and graphical structures associated with the data structures.

FIG. 7 is a depiction of exemplary data structures associated with navigation through a series of screens generated by a data system and graphical structures associated with the data structures, including a graphical notation indicating the presence of new data.

FIG. 8 is a depiction of a branching feature.

FIG. 9 is a depiction of an annotation feature.

FIG. 10 is a depiction of an exemplary client and server for implementing the embodiments.

### DETAILED DESCRIPTION OF THE PREFERRED EMBODIMENTS

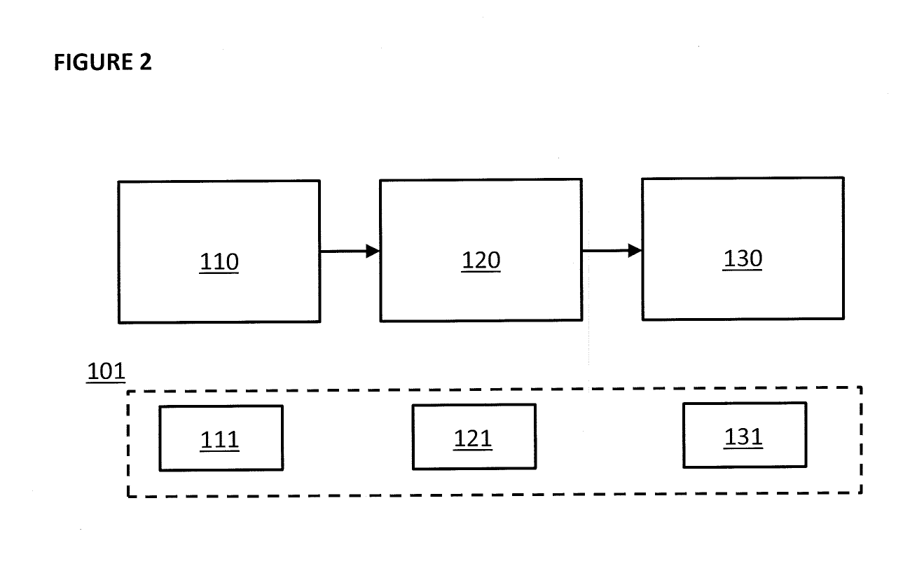

An embodiment is shown with reference to FIG. 2. As in the prior art, a user can navigate from screen 110 to screen 120 to screen 130. Screen 120 is a screen that can be accessed from screen 110, such as by clicking a link, entering data, or making a selection on screen 10. Similarly, screen 130 is a screen that can be accessed from screen 120, such as by clicking a link, entering data, or making a selection on screen 120.

Screen 110 is associated with data structure 111, screen 120 is associated with data structure 121, and screen 130 is associated with screen 131.

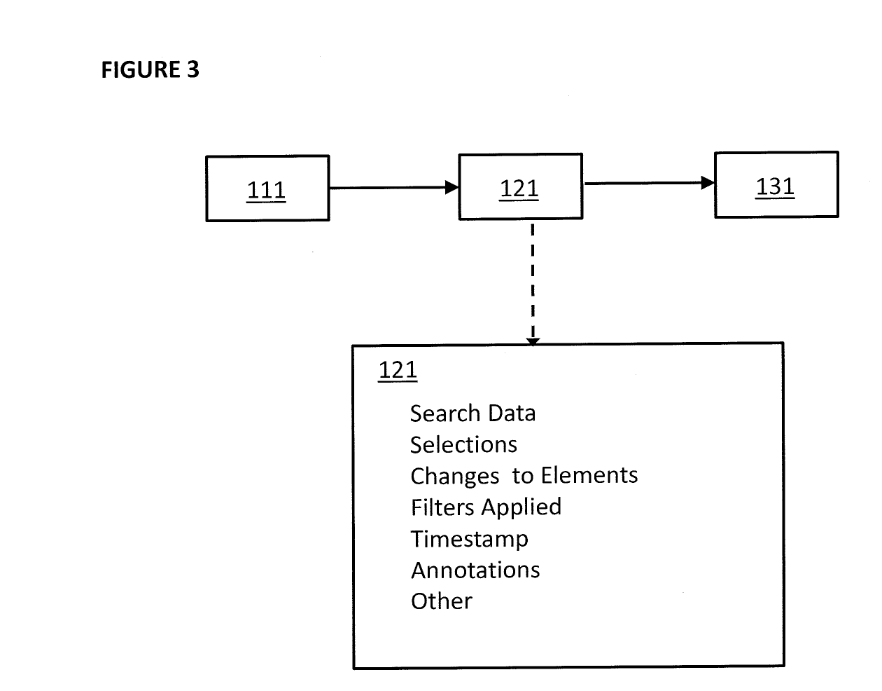

With reference to FIG. 3, data structures 111, 121, and 131 are displayed. Each can be conceptualized as a node or state. Each of data structures 111, 121, and 131 contain metadata that is the basis for the change from the prior screen to the screen with which it is associated. For example, data structure 121 contains data reflective of the events that occurred with respect to screen 110 that caused the traversal to screen 120. This data can include, for example:
Search Data: Data that a user entered into the prior screen, such as a search query
Selections: Selections made by a user on the prior screen, such as a link selection
Changes to Elements: Changes made to input devices on the prior screen, such as moving a sliding device
Filters Applied: Filters applied to data on the prior screen
Timestamp: Date and time when screen was first created or accessed
Annotations: Notes added by a user
Behavior: Natural language descriptions of actions the user took on the previous screen or screens.
Other: Other data reflective of actions taken on the prior screen

It is to be understood by one of ordinary skill in the art that data structures 111 and 131 can contain the same types of data as data structure 121. It is to be further understood that screens 110, 120, and 130 and data structures 111, 121, and 131 are offered for purposes of illustration only and that any number of screens and data structures can be used.

Unlike in the prior art, if a first user wishes to share data with a second user from a particular screen, the first user can send to the second user all data structures in the history that resulted in that particular screen.

For example, if a first user wishes to share screen 130 with a second user, the first user can send data structures 101 (which comprise data structures 111, 121, and 131) to the second user. With data structure 101, the second user would be able to replicate the entire sequence of navigation that resulted in screen 130.

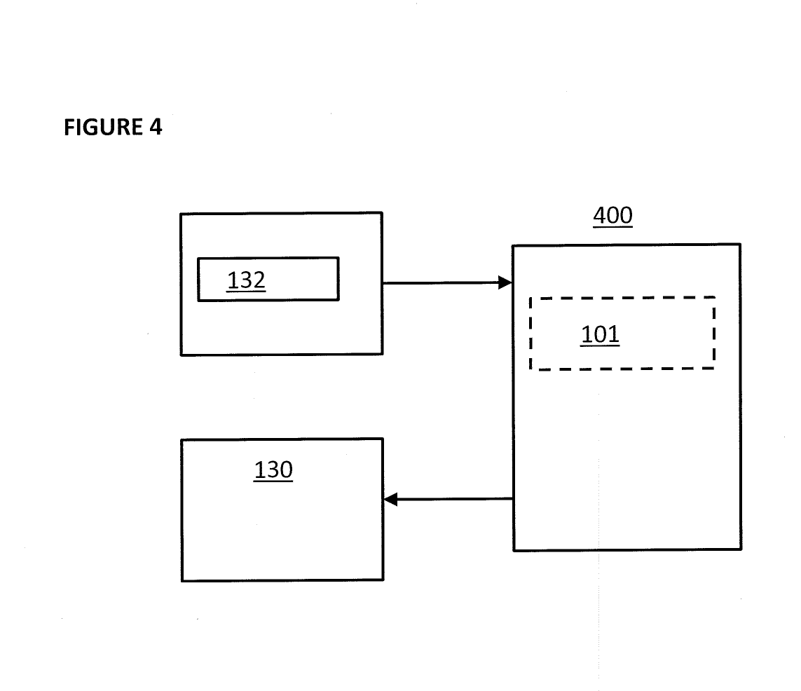

In a variation of the embodiment, with reference to FIG. 4, instead of sending data structure 101, the first user could send a permalink 132 associated with screen 130 and data structure 101. Permalink 132, when selected by the second user, would access data structure 101 in server 400, where it was previously stored, enabling the second user's computer system to regenerate screen 130.

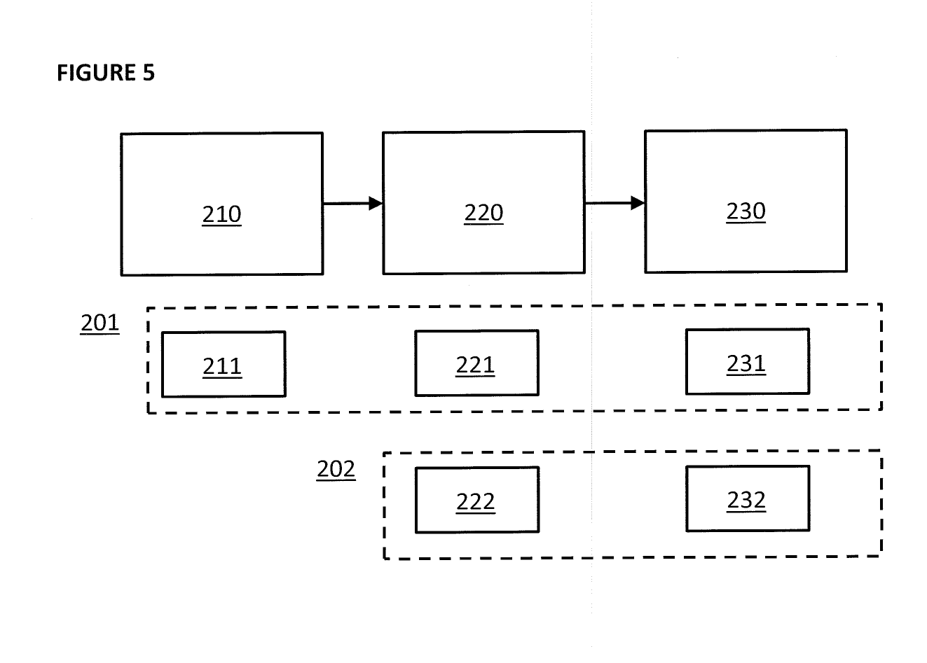

In another embodiment, a plurality of navigation data structures can be created. In FIG. 5, a user traverses from screen 210 to screen 220 and screen 230. Data structure 211 is created at the beginning of the navigation process. When the user traverses to screen 220, data structure 221 is created. At this point, the user elects to generate a second set of navigation data structures, for example, by hitting a “new” button. Data structure 222 is then created. When the user traverses to screen 230, data structure 231 is created, which is related to data structure 221. Data structure 232 also is created, which is related to data structure 222. The user then has the ability to share data structures 201 (comprising data structures 211, 221, and 231) or data structures 202 (comprising data structures 222 and 232). For example, a first user can share data structures 201 with a second user and can share data structures 202 with a third user.

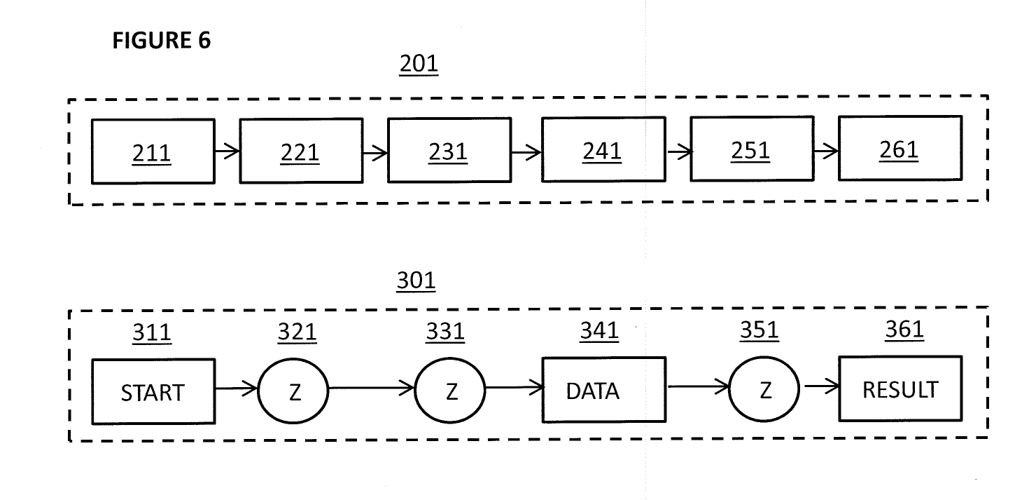

With reference to FIG. 6, an embodiment is disclosed where graphical representations 301 of data structures 201 are rendered. Data structures 201 comprise data structure 211, data structure 221, data structure 231, data structure 241, data structure 251, and data structure 261, which are generated during a user's navigation through a data system. Graphical representations 301 comprise graphical structure 311, graphical structure 321, graphical structure 331, graphical structure 341, graphical structure 351, and graphical structure 361. Graphical structure 311 represents data structure 211, graphical structure 321 represents data structure 221, graphical structure 331 represents data structure 231, graphical structure 341 represents data structure 241, graphical structure 351 represents data structure 251, and graphical structure 361 represents data structure 261.

In this particular example, graphical structure 311 represents the starting point for the navigation. Graphical structures 321, 331, and 351 represent situations where the user changed the underlying screen and data presentation by selecting data presented within the screen. For example, if a screen displays a facet of criteria for a dataset and a user selects one of those criteria, then a graphical structure such as graphical structure 321 (here, a “Z” for zoom) would be appropriate. Graphical structure 341 represents a situation where data is obtained from a server. For example, if a user selected a link or entered a query that caused data to be fetched from a server and displayed on the screen, then a graphical structure such as graphical structure 245 would be appropriate. Graphical structure 361 represents a situation where the final desired result is obtained.

The rendering of graphical structures 301 can occur during the initial navigation or during a subsequent replication of the navigation, as might happen after a first user shares his or her navigation history with a second user. The renderings can be viewed in conjunction with the underlying screens (for example, as a footer on the screen) or separately from those screens.

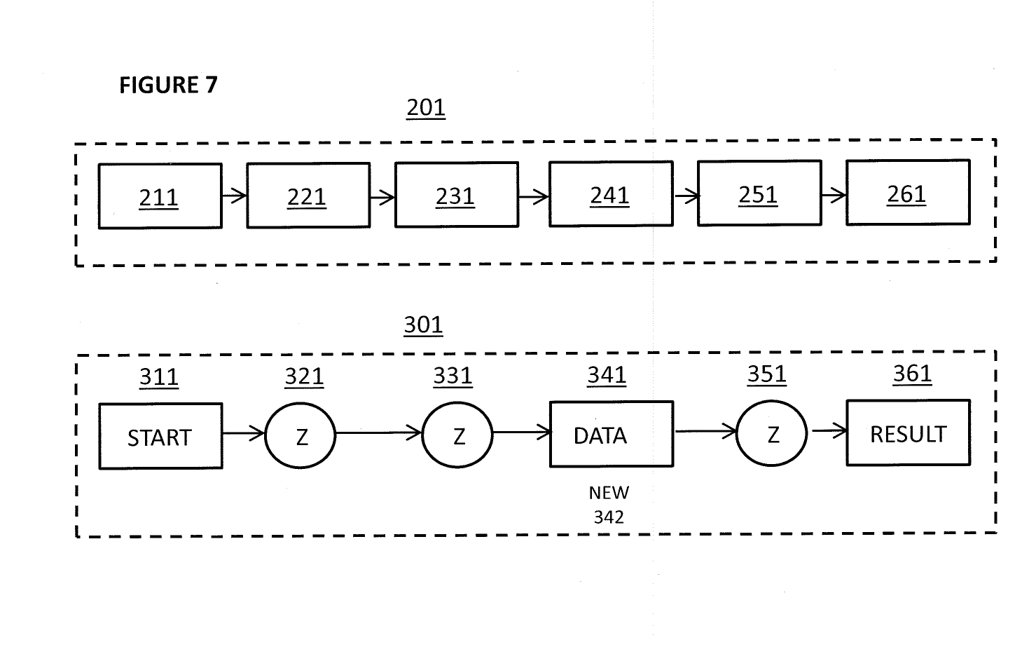

Another aspect of the invention is depicted in FIG. 7. Here, after data structure 201 is initially created, some of the data may change. For example, if data within data structure 241 is changed after data structure 241 is created, as might be the case, for example, if the data structure contains data reflecting the current value of a particular stock that is obtained from a server in real-time fashion, then the system can flag that change. It can do this because data structure 241 includes metadata reflecting the date and time that data structure 241 is created. If the system detects that data contained within data structure 241 has changed since the data and time of the data structure, then it can graphically depict this is graphical structure 341, for example, by including graphical notation 342, which here is the text “NEW.” In this manner, a user would be quickly informed that the data has changed since the first navigation.

In the alternative, data structure 241 could refresh its data and time stamp each time the data structure 241 or its associated screen is accessed and graphical notation 342 could be displayed if the data has changed since the last access.

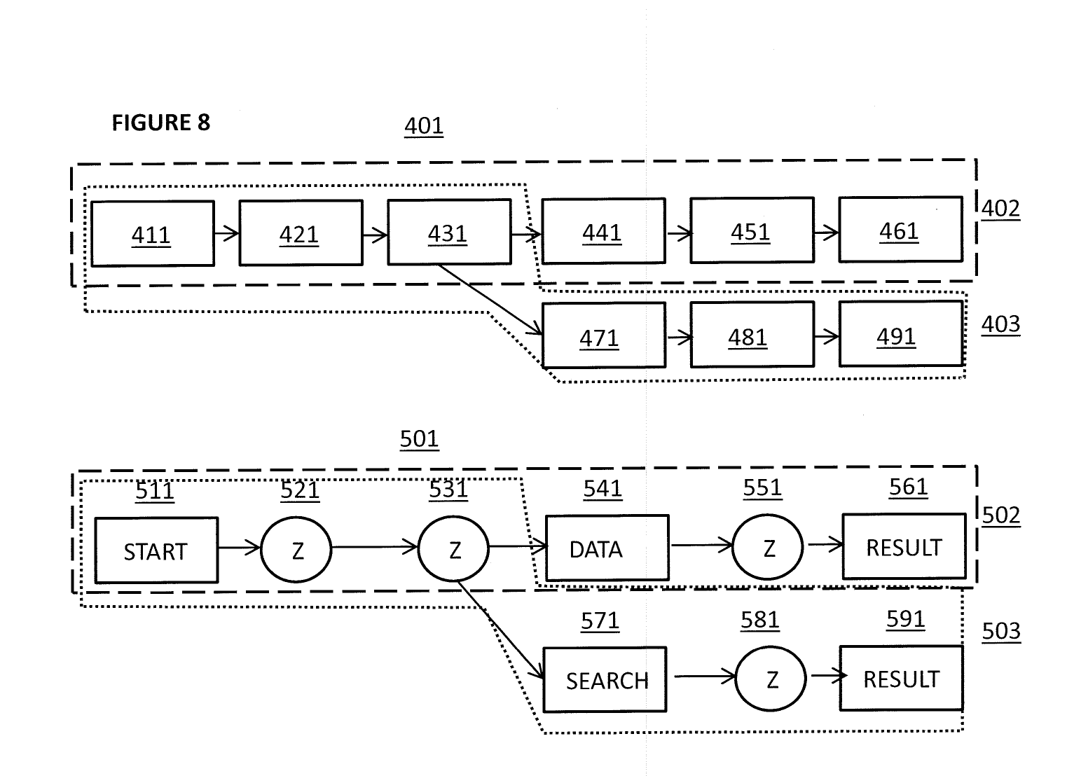

With reference to FIG. 8, a branching feature of the embodiments is disclosed. Graphical representations 501 of data structures 401 are rendered. Data structures 401 comprise first branch 402 and second branch 403. First branch 402 comprises data structure 411, data structure 421, data structure 431, data structure 441, data structure 451, and data structure 461, which are generated during a user's navigation through a data system. Graphical representations 501 comprise first branch graphical structure 502 and second branch graphical structure 503. First branch graphical structure 502 comprises graphical structure 511, graphical structure 521, graphical structure 531, graphical structure 541, graphical structure 551, and graphical structure 561. Graphical structure 511 represents data structure 411, graphical structure 521 represents data structure 421, graphical structure 531 represents data structure 431, graphical structure 541 represents data structure 441, graphical structure 551 represents data structure 451, and graphical structure 561 represents data structure 461.

In this example, a user can go back to graphical representation 531, associated with data structure 431, and take a different action than the one that previously led to graphical representations 541, associated with data structure 441. For example, a user could enter different search criteria or make a different selection among options, leading instead to data structure 471 and associated graphical representations 571. This creates a new branch in the navigation through the data set. Thereafter, a user can continue down this branch to data structures 481 and 491, associated with graphical representations 581 and 591. This results in second branch 403, which comprises data structures 411, 421, 431, 471, 481, and 491, and second branch graphical structure 503, which comprises graphical representations 511, 521, 531, 571, 581, and 591.

There is no limit to the number of branches that can be created, and branches can occur from any data structure or graphical representation.

When a user creates a branch, the renderings of graphical representations such as graphical representations 501 can display all branches or only the branch on which the user is currently navigating. For instance, as to the example of FIG. 8, at the user's option, the system could display first branch graphical structure 502 and second branch graphical structure 503 (comprising graphical representations 511, 521, 532, 541, 551, 561, 571, 581, and 591), or it could display only the first branch graphical structure 502 (comprising graphical representations 511, 521, 531, 541, 551, and 561) or the second branch graphical structure 503 (comprising graphical representations 511, 521, 531, 571, 581, and 591) depending on which branch the user is currently navigating.

Notably, regardless of whether all branches or only one branch is displayed, the system stores all of the data structures corresponding to all branches. This enables the system to replicate all previous sequences through the data set, including all branches. When the user shares data structures or navigation sequences with another user (using the techniques described previously), the user can share all branches or only certain branches.

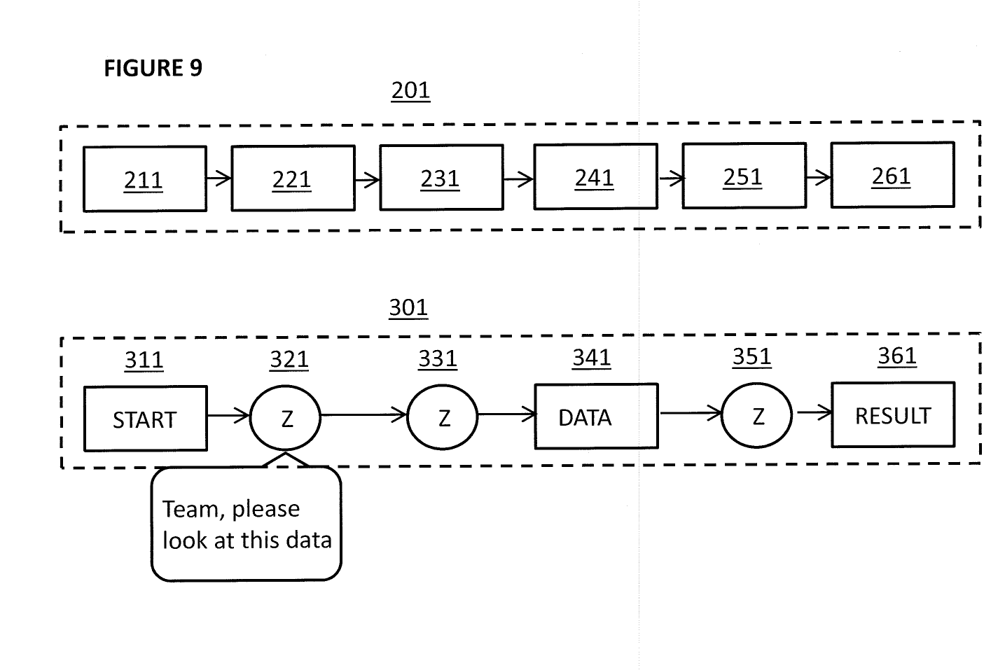

In another aspect of the embodiments, users have the option of adding annotations to a data structure. For example, as discussed previously for FIG. 3, data structure 121 (and other data structures) includes an Annotations field. With reference to FIG. 9, a user is able to add annotations to a data structure. FIG. 9 depicts data structures 201 and graphical representations 301 discussed previously for FIG. 6. In this example, a user enters an annotation in the annotations field associated with data structure 321 (e.g., “Team, please look at this data.”). The annotation is displayed as part of graphical representations 301. Thereafter, if data structure 321 or data structures 201 are shared with a second user, the second user would be able to access and view that annotation.

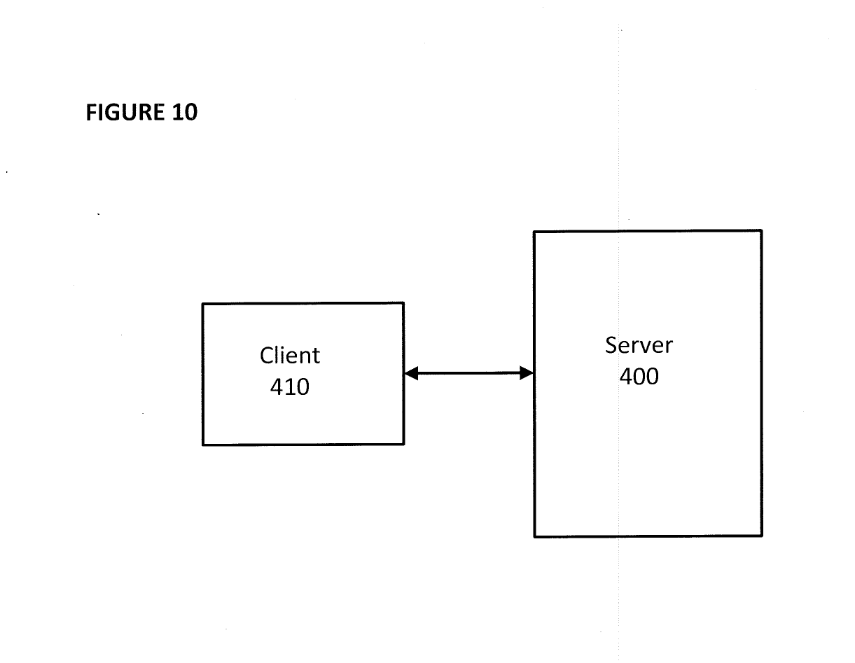

With reference to FIG. 10, client 410 and server 400 are depicted. Client 410 and server 400 each are computing devices and each comprise a processing unit, memory, non-volatile storage (such as a hard disk drive or flash memory array), and a network interface. Client 410 and server 400 communicate using known networking techniques, such as IP communication over the Internet. Client 410 is used to generate and display the various screens and graphical representations described in the embodiments, either during the initial navigation or during the replication process. Client 410 also is used to generate data structures during the initial navigation. In the alternative, or in addition to, server 400 also is used to generate data structures during the initial navigation. Server 400 also facilitates the sharing of data structures between users.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between). Likewise, the term “adjacent” includes “directly adjacent” (no intermediate materials, elements or space disposed there between) and “indirectly adjacent” (intermediate materials, elements or space disposed there between).

What is claimed is:

1. A computer storing a data structure representing the activity of a user through an application running on the computer, where the data structure enables the activity to be replicated and is capable of replicating each of the following:
a search query entered in the user interface;
selection of an option in the user interface; and
branching in the application.

2. The computer of claim 1, wherein the data structure is capable of replicating selection of a link presented by the computer in a user interface.

3. The computer of claim 1, wherein the data structure is capable of storing annotations entered by a user.

4. The computer of claim 1, wherein the data structure can replicate multiple instances of branching in the application.

5. A method of capturing and replicating the activity of a user through an application running on a computer, comprising:
capturing, in a data structure stored on a first computer, the activity of a user on an application running on the first computer, wherein the activity comprises one or more of the following:
entering a search query in a user interface presented by the application;
selecting an option in the user interface; and
branching in the application.
replicating, on a second computer, the activity using the data structure.

6. The method of claim 5, further comprising:
transmitting the data structure from the first computer to the second computer.

7. The method of claim 5, further comprises:
entering annotations in the user interface and storing the annotations in the data structure.

8. The method of claim 5, wherein the activity comprises multiple instances of branching in the application.

9. A method of capturing, replicating, and generating a visual representation of the activity of a user through an application running on a computer, comprising:
capturing, in a data structure stored on a first computer, the activity of a user on an application running on the first computer, wherein the activity comprises one or more of the following:
entering a search query in a user interface presented by the application;
selecting an option in the user interface; and
branching in the application.
generating, using the first computer, a first graphical representation of the activity;
replicating, on a second computer, the activity using the data structure; and
generating, using the second computer, a second graphical representation of the activity.

10. The method of claim 9, further comprising:
transmitting the data structure from the first computer to the second computer.

11. The method of claim 9, further comprising:
entering annotations in the user interface and storing the annotations in the data structure.

12. The method of claim 9, wherein the activity comprises multiple instances of branching in the application.

13. The method of claim 11, wherein the second graphical representation displays the annotations.

14. The method of claim 10, wherein the transmitting step comprises sending a permalink.

15. The method of claim 9, wherein the capturing step is initiated in response to a user command.

16. The method of claim 15, wherein the capturing step is terminated in response to a user command.

17. The method of claim 9, further comprising:
storing the data structure in a server.

18. The method of claim 12, further comprising:
providing, on the second computer, the option of displaying graphical representations of one branch or multiple branches.

19. The method of claim 18, further comprising:
entering annotations in the user interface and storing the annotations in the data structure.

20. The method of claim 19, wherein the second graphical representation displays the annotations.
